(19) United States
(12) Patent Application Publication
(10) Pub. No.: US 2010/0005481 A1
(43) Pub. Date: Jan. 7, 2010

(54) Method of Maintaining Applications in a Computing Device

(75) Inventors: Simon Lewis, London (GB); Ivan Litovski, London (GB)

Correspondence Address: Saul Ewing LLP (Philadelphia), Attn: Patent Docket Clerk, 2 North Second St., Harrisburg, PA, 17101, US

(73) Assignee: NOKIA CORPORATION, Espoo (FI)

(21) Appl. No.: 11/721,875

(22) PCT Filed: Dec. 15, 2005
(86) PCT No.: PCT/GB2005/004866

§ 371 Date: Jun. 15, 2007

(30) Foreign Application Priority Data
Dec. 15, 2004 (GB) 0427474.2

(51) Int. Cl. G06F 9/44; G06F 9/54

(52) U.S. Cl. 719/320; 719/318; 719/328

(57) ABSTRACT

A method is provided for managing the application lifecycle for user applications on a computing device. The method can centrally manage
application lifecycle (including installation, execution status, removal)
application capabilities
long-lived OS level application owned resources (e.g. push connections, alarms)
security
   for any application, regardless of application type or model or execution environment.

The present invention relates to a method of maintaining applications in a computing device, and in particular, to a method of managing the lifecycle of user applications together with their associated resources by the operating system on a computing device in a unified way irrespective of the application type or execution environment.

The term computing device as used herein is to be expansively construed to cover any form of electrical computing device and includes, data recording devices, computers of any type or form, including hand held and personal computers, and communication devices of any form factor, including mobile phones, smart phones, communicators which combine communications, image recording and/or playback, and computing functionality within a single device, and other forms of wireless and wired information devices.

Application management was not an issue for many computing devices until about twenty years ago. When applications were loaded individually, either from tape or from disk, by the operator or user, the one-to-one correspondence between applications and media meant that the operator or user always knew exactly what was loaded; and while early multi-user operating systems allowed multiple applications to be loaded simultaneously, the interactions between the operating system and such applications were generally very predictable, and the interactions between the applications themselves were fairly minimal. In essence, applications at that time could be divided into two types: those than were running and those that were not.

However, the widespread availability of low cost high capacity disk storage has reduced the marginal effort involved in loading applications to almost zero. The widespread availability of low cost memory has largely negated the memory contention problems that resulted from having multiple applications loaded. And, the continued evolution of operating systems has resulted in the production of rich shared libraries and common application programming interfaces (APIs) which have encouraged inter-process communication.

Together, these three developments have fostered the concept of a third type of application. Hence, in addition to the two types of applications referred to above, i.e. those that were running and those that were not, there is now a third category—“installed” applications. These applications are not running applications, but they are available to be loaded into local storage, and they have generally made some changes to the operating system at the time they were installed: for example, updating or installing system libraries, or altering the system registry.

It is highly desirable for some order and structure to be brought to the business of installing applications on modern computing devices. Were each application free from any central management, the resulting anarchy could easily destabilise the entire operating system and the functioning of the computing device itself would then be at risk.

A fourth development has given the requirement for the proper management of applications even further impetus. This is the growth in connectivity which has resulted from the widespread availability of cheap public internet usage, the increased use of permanently connected fixed and mobile computing devices, and the explosion in the use of networked applications such as web browsing and email. These changes have combined to make users aware that the security of computing devices and their susceptibility to electronic attack has now become a mainstream issue rather than an academic one. Although the history of electronic attacks is over twenty years old (the first computer virus was devised as long ago as 1983), it is the growth of connectivity that has made this a serious threat, to which virtually all users of computing devices have felt exposed.

Today's open operating systems may implement a wide range of application management and security solutions; however, they all have a relatively standard approach to the problem of managing the application lifecycle. This is to provide a non-mandatory application manager, with which applications may register. installation and removal mechanisms, which may or may not be application specific, but are usually bound to the traditional application model of native executables and their resources.

Users of Microsoft operating systems on desktop computers will be familiar with this approach, as it is used by the Windows installer as well as third-party mechanisms such as Install Shield. Those applications wishing to can register with the application manager and follow its operational guideline; if they do so, central services such as the Control Panel will know about them and will offer options for their removal. However, there is no obligation on applications to install or remove themselves using this mechanism.

The same model is used by a number of Linux distributions, notably the Red Hat Package Manager (RPM) and Debian's Advanced Packaging Tool (APT), which take care of application installation and removal, but do not address the possibility that the mechanism can be bypassed.

This model was also used by the Symbian OS™ operating system available from Symbian Limited of London, in all versions up to version 8, via the Symbian Installation System (SIS) and the associated AppInst architecture.

Although the application management model as used in a modern Operating System (OS) is relatively simple to implement and maintain, it suffers from a number of concerns that can be grouped into three main areas.

### 1. Lack of Interaction Between Application Lifecycles Stages

These concerns all relate to a fundamental lack of interaction between the various application lifecycle stages (which include loading, execution and termination as well as installation and removal).
Whilst the application manager manages installation and removal, it is a separate component that is not present when an application is actually executing. The fact that this part of the application lifecycle is not monitored means that the security and integrity of the operating system and other running programs may be compromised.
On some systems (such as Windows PCs) this problem is partially managed by separate resident security monitoring processes; but these have no knowledge of the installation process and cannot check actions against any implied installation contract concerning what an application has declared it might do.
Most operating systems allow arbitrary programs to be executed in many different ways, notwithstanding that their existing application models do not implement network security and have rudimentary filesystem security. Permissions are generally implicit and assigned per user, not per executable. This is a serious issue because in this scenario, users unaware of malicious or mischievous code (malware) in an executable can compromise not only their own files, but also other computers on the network and, in some circumstances, system files. These security issues are discussed in more detail below.
An application may not own resources while it is not running, nor prevent another application from using them. This is not necessarily a problem, but there are some situations where security concerns demand that a particular resource is either reserved for a particular trusted application or is maintained in a particular state. Although some operating systems do provide limited functionality (for example, inetd on Linux), it is necessary on most systems for separate processes to be implemented to maintain or reserve such resources.
When an application manager has no control over certain stages of the lifecycle, it limits its ability to handle situations where uninstallation is requested for an application that is currently running. Developers have to resort to kludges, such as asking users to reboot their systems to complete removal of an application. A kludge is known to persons familiar with this art as an awkward or clumsy (but at least temporarily effective) solution to a programming or hardware design or implementation problem.

### 2. Lack of Support for Multiple Application Models

A further problem is that although OS application management systems allow the installation and removal of many different types of file (including data files and documentation) they are nevertheless focused on a single application model. Usually, this is the native executable; that is to say, a program that is loaded directly by, and interacts directly with, the host operating system. However, on most computing devices, there are also going to be additional application models that need to be supported, for executables that are either loaded by running applications rather than the operating system, or whose interaction with the operating system is mediated by other executables, or both. Examples of these additional application models include:
interpreted executables (as found in varieties of BASIC, including both Visual Basic Appforge for mobile devices as described at http://www.appforge.com)
intermediate code executables (such as PASCAL p-code and Java bytecode)
applications with embedded macro languages (such as Microsoft Office applications, including VBA enabled languages)
applications that are loaded by running applications but then execute natively within them (such as rendering plug-ins for browsers)
applications that use other applications as operating environments (internet scripting applications such as Javascript that run in browsers)
applications which need to be managed by private application management software (AMS) (such as midlets from Java or BREW from Qualcomm)
   Note that the above is not intended to be a comprehensive list of non-native executables, and others will be apparent to those skilled in this art.

Existing OS Application Management Systems can support these models only partially; full support for these additional application models needs to be handled through separate application management systems.

### 3. Lack of Unified Security Mechanism

This issue has already been referred to in the discussion of the problems which arise from the lack of interaction between the stages of the entire application lifecycle.

The concern for existing OS management systems is that although they can implement some form of perimeter security on installation (enabling, for example, a user to be notified of unsigned applications and enabling certificates to be checked on signed applications) there is no unification of perimeter security with run-time security. As a result, open operating systems (which allow additional programs to be installed post-manufacture by the user or owner) allow arbitrary programs to be executed in many different ways. This lack of run-time security generally leaves resources accessible via both the network and the file system security open to such programs. Where permissions do exist, they are implicit and are assigned on a per user basis, not per executable. Consequently, users unaware of malware in an executable can compromise their own files, other computers on the network and in some circumstances system files.

The problem areas described above are applicable to application management systems implemented at the operating system level. However, a somewhat different approach has been taken by the Java technology developed by Sun Microsystems.

Java technology is “a portfolio of products that are based on the power of networks and the idea that the same software should run on many different kinds of systems and devices” (from http://java.sun.com/) and version 2.0 of the Java 2 Micro Edition (J2ME) Mobile Information Device Profile (MIDP) introduced the notion of a managed application.

Traditional applications are relatively autonomous once loaded and primarily depend on user input to manage their lifecycle. However, managed applications are at all times under the control of the underlying operating system, which can suspend or resume their operation, or even kill an application completely.

The requirement for AMS to be installed on a computing device is a specific requirement for J2ME MIDP 2.0. Sun define AMS as the “software in the device that's responsible for each application's life-cycle (installation, activation, execution, and removal)”. A short overview of application management in J2ME can be found at http://sun.systemews.com/articles/56/3/ja/7939 which describes four application models. These models are the traditional unmanaged application, applets which are managed by a web browser, midlets, and xlets. The last two of these, midlets and xlets, are managed by AMS.

For an example of the way that J2MW AMS implementations implement these requirements in practice, see http://www-106.ibm.com/developerworks/library/wi-amspalm/?ca=dgr-lnxw03AMS, which describes an implementation on the PalmOS™ operating system from Palm Inc of USA.

It might be thought that the requirements made by Java AMS of the underlying OS provide partial solutions to certain difficulties mentioned above in connection with an OS application management system; namely:
Management of application owned OS level resources (such as push connections and alarms) whose lifetime extends beyond that of the running application.
Instantiation of an application owned by OS level resources at application installation time.
Management of multiple application launch methods (such as user activity, connection activity and alarm activity).

However, the Java AMS can only manage the entire lifecycle for two application models (midlets and xlets). The Java AMS cannot handle Java applets (which have to be managed by a web browser) or unmanaged Java applications. Most importantly, non-Java applications cannot be managed at all. Even Java applications may not be fully policed if they have been installed outside the provided AMS. As the PalmOS™ AMS cited earlier acknowledges, the Java AMS can recognise “only MIDlets that it has installed itself, and not those transferred onto the device by other means.”

So although the Java AMS system described in the J2ME MIDP specification partially alleviates some of the problems identified above, it suffers from the fatal flaw that it can only police certain types of J2ME managed applications, and furthermore, these need to have been downloaded and installed via J2ME itself. Where Java is implemented on top of an open OS, this approach is clearly insufficient, because it allows native applications to go unmanaged.

Hence, it is an object of the present invention to provide an improved solution to the problems described above through the provision of a method that can centrally manage at least all of the following:
the complete application lifecycle (installation, loading, all the various execution states, termination, and removal)
application capabilities (for instance, based on MIME types)
long-lived OS level application owned resources (for example, push connections or schedules events and alarms, which may be associated with specific executables)
security.

Moreover, the method is also able to fulfill the above requirements not only for all types of native applications, but also for applications belonging to any other managed or unmanaged subsystem, including, but not limited to, Java applications, interpreted applications such as Perl or Basic scripts, and applications conforming to hosted alien application environments such as J2ME AMS or BREW (Binary Runtime Environment for Wireless) from Qualcomm. These environments are considered to be well known to persons skilled in this art and will not therefore be described further in the context of the present application.

Thus, according to a first aspect of the present invention there is provided a method of managing application lifecycle for user applications on a computing device, the method comprising providing an application management system (AMS) for managing a plurality of application models and a plurality of application environments, wherein the AMS is implemented as a component within an operating system for the computing device and grants to the operating system control for all application management functionality on the device.

According to a second aspect of the present invention there is provided a computing device arranged to operate in accordance with a method of the first aspect.

According to a third aspect of the present invention there is provided an operating system for a computing device for causing the computing device to operate in accordance with a method of the first aspect.

An embodiment of the present invention will now be described, by way of further example only, with reference to the accompanying drawings, in which:

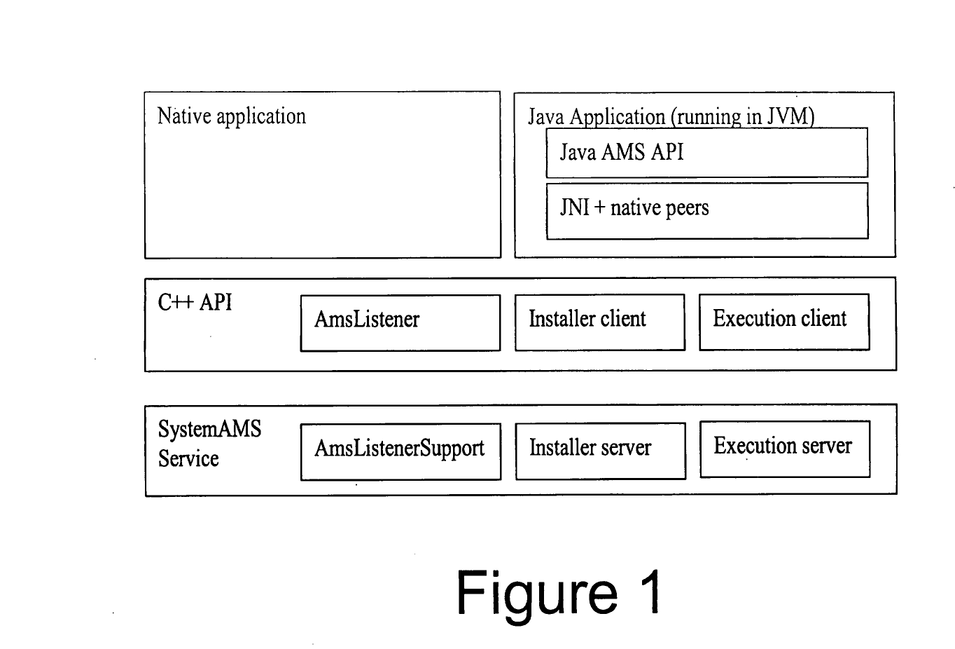

FIG. 1 shows the overall architecture of an application management system (AMS) in accordance with the present invention; and

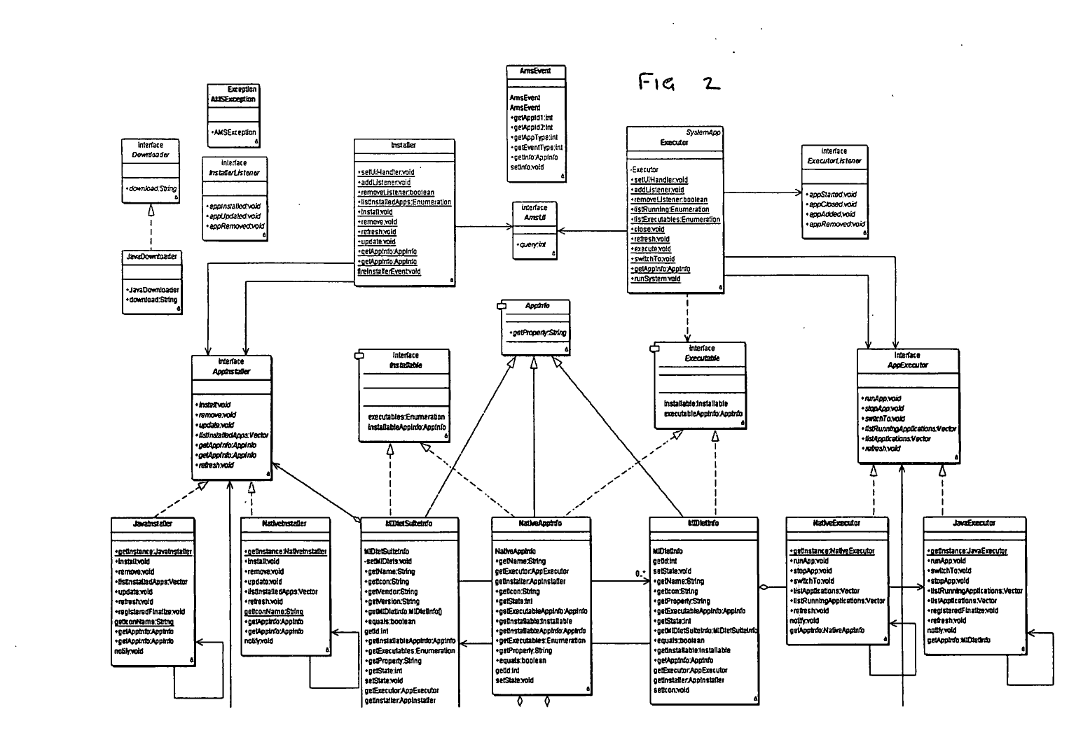

FIG. 2 shows the application program interfaces for the AMS illustrated in FIG. 1.

The embodiment of the present invention is described below with reference to a generic AMS OS service which manages applications by maintaining
a registry of installed applications
the state of all running applications
operating system resources
   Furthermore, the method as described below is extensible; additional subsystems can be added to the architecture.

The preferred implementation described below shows how to implement such a generic AMS system for both native applications and Java applications on a computing device using the Symbian OS™ operating system, the advanced operating system for mobile computing devices from Symbian Software Ltd. However, it will readily be appreciated by those skilled in the art that this invention can be implemented on other operating systems, and on other types of computing devices. Furthermore, the disclosure of the method of managing Java applications described in the present invention will allow those skilled in the art to discern how to apply the same method to other non-native subsystems, either singly or in combination. The use of Symbian OS™ operating system and Java in this embodiment of the invention is therefore provided solely for the purposes of illustration and is not intended to limit the application or scope of the invention in any way whatsoever.

Firstly, an overview of AMS architecture will be provided. In the preferred example implementation presented here, the AMS service provides several layers of functionality, from the front-end, “shell” applications, to the back-end RDBMS (relational database management system) based application information storage. The overall architecture of the AMS components is presented in FIG. 1.

It can be seen from FIG. 1 that native application and non-native subsystems (here represented by Java applications running in a Java Virtual Machine, or JVM) are provided with a C++ application program interface (API), which provides access to common functionality, such as AmsListenerSupport, Installer server, and Execution server, within AMS. It can be seen from FIG. 2 that this API is accessed directly by native applications. However, applications running in non-native subsystems must, if they cannot access native operating system methods, be provided with insulation layers with which they can communicate. Hence, the non native Java application shown in FIG. 1 implements AMS functionality through the provision of a Java API and Java Native Interfaces (JNI). Likewise, other non-native application environments, not shown in FIG. 1, may need to provide their own insulation layers.

The C++ API is shown in FIG. 1 to communicate with the System AMS services. Preferably, a client/server architecture is used, because there are many possible types of applications, which all have to communicate with a single AMS service. There are two main sets of classes in this architecture; the Installer client/server classes, which handle the single-instance installation and removal events and procedures, and the Execution client/server classes, which handle the multiple-instance events and procedures associated with each instance of an application loading, running and terminating.

Associated with the Installer and Execution classes are Listener classes which provide event notifications. The exact mechanism by which this is done may vary; for example, callbacks or publish-and-subscribe are both suitable mechanisms. Other mechanisms will be evident to persons familiar with this art.

Message exchange between AMS service and application processes is performed using inter process communication (IPC). The AMS Service interacts with application processes in several ways:
Firstly, an API is provided for AMS application development. Subject to their granted security permissions, applications can perform tasks including (but not limited to) installing and removing applications, listing installed applications, listing running applications, querying application information, running and closing applications, and sending them to the background or bringing them to the foreground.
Secondly, AMS interacts with managed application processes. Managed applications may be asked to close or be terminated in response to an AMS API call or other operating system level event. Applications may also request or release operating system level application owned resources, such as push connections.
Thirdly, AMS provides notification events. Subject to their granted security permissions, applications can request notifications of AMS events such as lifecycle state changes which include (but are not limited to)
   installed
   removed
   started
   suspended
   resumed
   stopped.

Apart from leaving programs with the ability to terminate execution (exit), the AMS provides the only means for triggering application lifecycle state changes. AMS is therefore the only available means for installation, removal and activation of executables on the device.

This application model of the AMS is both very flexible and very extensible. The AMS structure consists of multiple tiers. At the highest level, the user interacts with AMS through familiar system applications such as the installer (which adds or removes user applications) and the desktop (which enables users to pick and launch applications). Beneath this highest level, AMS provides a set of public APIs providing controlled access to required functionality affecting lifecycle state changes, including querying assigned permissions or requesting additional permissions. At the lowest level, the AMS model interacts with the operating system kernel which implements the necessary tasks. AMS also requires access to non-volatile storage for data persistence; the SymbianOS™ operating system implementation uses an RDBMS back end for this purpose. Such an implementation can be seen from FIG. 1.

The preferred form of application model defines a set of interfaces necessary to support a variety of application models. A diagram of the AMS structure and associated application programming interfaces is shown in FIG. 2. The public classes shown in FIG. 2 are listed in detail in the practical example set out below. Together, these classes demonstrate how to provide an object model of public interfaces that handle multiple different application models (in this case, J2ME MIDP and native applications).

As has been stated previously, the top level abstraction distinguishes between Executables and Installables. The Application Representation Object (ARO) class is constructed by extending an existing AppInfo class, and implementing Executable and Installable methods. These may be implemented as pairs or singly, as necessary. As examples, it can be seen from FIG. 2 that the MIDletInfo class heading only implements Executable class methods and the MIDletSuiteInfo class heading only implements Installable methods, whereas the NativeAppInfo class heading implements both Executable and Installable class methods.

The Executable and Installable interfaces define methods that allow AMS to obtain specialised AppExecutor and AppInstaller objects that are used to perform actual installation or execution. Each Executable and Installable implementation would typically have a corresponding AppExecutor or AppInstaller implementation.

It has also been stated previously that Listener classes are also used for interaction with AMS; these include ExecutorListener and InstallerListener. An object of a class that implements these interfaces may be registered with Executor or Installer to obtain corresponding notifications.

AMS interactions, such as prompts or progress dialogs are abstracted into a high level interface, shown as AmsUI in FIG. 2.

It is worth noting that that the two classes central to this AMS structure are Executor and Installer. They define AMS tasks and implement them by delegating relevant instances to registered AppExecutor and AppInstaller class methods.

Suitable methods need to be defined for any non-native application environment. FIG. 2 shows an example of how this may be been done for Java by means of the JavaInstaller and JavaExecutor classes. Note that non-native application environments also need to derive suitable classes from AppInfo; again, FIG. 2 shows how this may be done for Java Midlets.

With regard to security, implementing a single central Application Management entity facilitates the consistent installation-time assignment of per-executable permissions. Such an approach allows the adoption of a permission (or capability) based execution model, such as the platform security model disclosed in patent application GB 0312191.0 entitled “Secure Mobile Wireless Device”.

Those skilled in the art will appreciate that this highly controlled environment stands in stark contrast to more conventional AMS models.

Typically, permissions or capabilities are assigned during installation, based on credentials (certificate) presented by the application. Permissions are then persisted by AMS and made available to execution (runtime) environments.

Applied to the embodiment described above, in the J2ME MIDP2 context, the permissions and enforcement may directly correspond with the J2ME MIDP2 security model. For native applications, installation may involve verification of capabilities required by the application. In both cases, execution time permission/capability checking is a built-in feature of the runtime model and associated APIs.

An example of an implementation of the AMS structure according to the present invention will now be provided. The terms used in the following implementation will be readily understood by persons skilled in this art and will not, therefore, be described further in the context of the present application.

From FIG. 2, it can be seen that the AMS structure comprises of six interfaces, and the function of these interfaces are as follows:

Interface Summary

| | |
|---|---|
| AmsUI | The AmsUI interface allows applications to customise |
| | the display of query, information, warning and error |
| | messages that are required by the AMS. |
| Downloader | Abstraction of download capability for installation |
| | allows customisation of the downloading mechanism. |
| Executable | Interface common to all executable applications. |
| ExecutorListener | The ExecutorListener interface defines a set of call- |
| | back methods allowing AMS application to be aware |
| | of changes external to the process the are executing in. |
| Installable | Interface common to installable applications. |
| InstallerListener | By implementing this interface applications can |
| | subscribe to notifications of installation, update and |
| | uninstallation of applications. |

The classes associated with these interfaces are as follows:

Class Summary

| | |
|---|---|
| AmsEvent | AmsEvent is used for passing messages between |
| | application management API and applications. |
| AppInfo | AppInfo is a generic application descriptor class. |
| Executor | The executor class capable of starting, stopping |
| | switching between and querying currently available |
| | and running applications. |
| Installer | The installer provides the necessary methods for |
| | installation of both, MIDlet suites and native |
| | applications. |
| JavaDownloader | Simple implementation of the Downloader interface |
| | allowing installation from local drive. |
| MIDletInfo | Holds basic MIDlet information. |
| MIDletSuiteInfo | Holds basic MlDletSuite information. |
| NativeAppInfo | NativeAppInfo is a native application descriptor. |

Exception Summary

| | |
|---|---|
| AMSException | Thrown on application management errors. |

The details and functions of the classes used in the AMS are as follows:

### Class AmsEvent

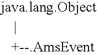

public class AmsEvent
extends java.lang.Object

AmsEvent is used for passing messages between application management API and applications.

An application will typically register its listener with Installer or Executor classes to receive event notifications such as that an application was installed or run.

Field Summary

| | |
|---|---|
| static int | APP_JAVA_MIDLET |
| | Defines the application type for java MIDlets. |
| static int | APP_NATIVE_APP |
| | Defines the application type for native applications. |
| static int | EVENT_APP_INSTALLED |
| | Defines the event type for application installed event. |
| static int | EVENT_APP_REMOVED |
| | Defines the event type for application removed event. |
| static int | EVENT_APP_STARTED |
| | Defines the event type for application started event. |
| static int | EVENT_APP_STOPPED |
| | Defines the event type for application stopped event. |
| static int | EVENT_APP_UPDATED |
| | Defines the event type for application updated event. |
| static int | EVENT_EXE_ADDED |
| | Defines the event type for executable added event. |
| static int | EVENT_EXE_REMOVED |
| | Defines the event type for executable removed event. |

Method Summary

| | |
|---|---|
| int | getAppId1( ) |
| | Return the main application ID. |
| int | getAppId2( ) |
| | Return the second application ID. |
| int | getAppType( ) |
| | Returns application type for this event. |
| int | getEventType( ) |
| | Returns event type for this event. |
| AppInfo | getInfo( ) |
| | Obtain the application descriptor for the application this event is |
| | associated with. |

Methods inherited from class java.lang.Object
clone, equals, finalize, getClass, hashCode, notify, notifyAll, toString, wait, wait, wait

### Field Detail

### EVENT_APP_INSTALLED

public static final int EVENT_APP_INSTALLED

Defines the event type for application installed event.

### EVENT_APP_UPDATED

public static final int EVENT_APP_UPDATED

Defines the event type for application updated event.

### EVENT_APP_REMOVED

public static final int EVENT_APP_REMOVED

Defines the event type for application removed event.

### EVENT_APP_STARTED

public static final int EVENT_APP_STARTED

Defines the event type for application started event.

### EVENT_APP_STOPPED

public static final int EVENT_APP_STOPPED

Defines the event type for application stopped event.

### EVENT_EXE_ADDED

public static final int EVENT_EXE_ADDED

Defines the event type for executable added event.

### EVENT_EXE_REMOVED

public static final int EVENT_EXE_REMOVED

Defines the event type for executable removed event.

### APP_JAVA_MIDLET

public static final int APP_JAVA_MIDLET

Defines the application type for java MIDlets.

### APP_NATIVE_APP

public static final int APP_NATIVE_APP

Defines the application type for native applications.

### Method Detail

getAppId1
public final int getAppId1( )

Return the main application ID. For java MIDlets this corresponds to MIDlet suite ID.

For native applications this is application ID.

Returns:

Application ID

getAppId2
public final int getAppId2( )

Return the second application ID. For java MIDlets this corresponds to MIDlet ID.

For native applications this value can be ignored.

Returns:

Second application ID

getAppType
public final int getAppType( )

Returns application type for this event.

Returns:

Application type for this event.

getEventType
public final int getEventType( )

Returns event type for this event.

Returns:

Event type for this event.

getInfo
public AppInfo getInfo( )

Obtain the application descriptor for the application this event is associated with.

Returns:

The application descriptor for the application this event is associated with.

### Class AMSException

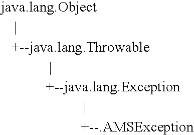

### All Implemented Interfaces:

java.io.Serializable

public class AMSException
extends java.lang.Exception
Thrown on application management errors.

### Constructor Summary

AMSException (java.lang.String aMessage)

Create a new AMSException with the specified message.

Methods inherited from class java.lang.Throwable
fillInStackTrace, getCause, getLocalizedMessage, getMessage, getStackTrace, initCause, printStackTrace, printStackTrace, printStackTrace, setStackTrace, toString
Methods inherited from class java.lang.Object
clone, equals, finalize, getClass, hashCode, notify, notifyAll, wait, wait, wait

### Constructor Detail

### AMSException

public AMSException(java.lang.String aMessage)

Create a new AMSException with the specified message.

### Parameters:

aMessage—the message String

### Interface AmsUI

public interface AmsUI

The AmsUI interface allows applications to customise the display of query, information, warning and error messages that are required by the AMS.

Typical implementation will implement the query method by examining the query type, adding options and then displaying the dialog.

This interface may be extended to allow bringing up custom dialogs such as installation progress.

Field Summary

| | |
|---|---|
| static int | ERROR |
| | Defines the ERROR dialog type. |
| static int | INFO |
| | Defines the INFO dialog type. |
| static int | OPT_CANCEL |
| | Defines the CANCEL option. |
| static int | OPT_NO |
| | Defines the NO option. |
| static int | OPT_OK |
| | Defines the OK option. |
| static int | OPT_YES |
| | Defines the YES option. |
| static int | QUERY |
| | Defines the QUERY dialog type. |
| static int | WARNING |
| | Defines the WARNING dialog type. |

Method Summary

| | |
|---|---|
| int | query(int aType, int aOptions, java.lang.String aQueryString) |
| | Present the user with a message or query. |

### Field Detail

### OPT_YES

public static final int OPT_YES

Defines the YES option.

This value is used both as parameter and return value in the query method.

### OPT_OK

public static final int OPT_OK

Defines the OK option.

This value is used both as parameter and return value in the query method.

### OPT_NO

public static final int OPT_NO

Defines the NO option.

This value is used both as parameter and return value in the query method.

### OPT_CANCEL

public static final int OPT_CANCEL

Defines the CANCEL option.

This value is used both as parameter and return value in the query method.

### QUERY

public static final int QUERY

Defines the QUERY dialog type.

### INFO

public static final int INFO

Defines the INFO dialog type.

### WARNING

public static final int WARNING

Defines the WARNING dialog type.

### ERROR

public static final int ERROR

Defines the ERROR dialog type.

### Method Detail

query

```
public int query(int aType,
            int aOptions,
            java.lang.String aQueryString)
```

Present the user with a message or query.

This method is synchronous and should only return when the query dialog has been dismissed.

Parameters:

aType—One of QUERY, INFO, WARNING, ERROR

aOptions—OR combination of OPT_YES, OPT_OK, OPT_NO, OPT_CANCEL

aQueryString—The string to present to the user.

Returns:

Based on user response, the return value should be one of OPT_YES, OPT_OK, OPT_NO, OPT_CANCEL

### Class AppInfo

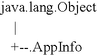

### Direct Known Subclasses:

### MIDletInfo, MIDletSuiteInfo, NativeAppInfo

public abstract class AppInfo
extends java.lang.Object

AppInfo is a generic application descriptor class.

The EJF AMS framework supports both native applications and Java MIDlets. These two application types are quite different in the way they are installed and managed. Additionally, Java MIDP specification has a notion of MIDlets as runnable applications and MIDlet suites as installable application suites. In effect, one can only run MIDlets, and can only install/uninstall MIDlet suites. Native applications are somewhat simpler in that they are atoms in both installation and execution.

As an abstract base class for all applications, AppInfo is agnostic of whether they can be installed or run.

Since installation and execution of different application types is done in different ways, such tasks are delegated to application type specific implementors.

Field Summary

| | |
|---|---|
| static int | RUNNING |
| | Constant that corresponds to the RUNNING state in |
| | application lifecycle. |
| static int | STOPPED |
| | Constant that represents all application states other than |
| | RUNNING. |

### Constructor Summary

### AppInfo( )

Method Summary

| | |
|---|---|
| abstract java.lang.String | getIcon( ) |
| | Get the application icon. |
| abstract java.lang.String | getName( ) |
| | Get the application name. |
| abstract java.1ang.String | getProperty(java.lang.String aPropertyName) |
| | Get an application property. |
| abstract int | getState( ) |
| | Get the application state. |

Methods inherited from class java.lang.Object
clone, equals, finalize, getClass, hashCode, notify, notifyAll, toString, wait, wait, wait

### Field Detail

### STOPPED

public static final int STOPPED

Constant that represents all application states other than RUNNING.

### RUNNING

public static final int RUNNING

Constant that conesponds to the RUNNING state in application lifecycle.

### Constructor Detail

### AppInfo

public AppInfo( )

### Method Detail

getName
public abstract java.lang.String getName( )

Get the application name.

Returns:

the application name

getIcon
public abstract java.lang.String getIcon( )

Get the application icon.

Returns:

the application icon

getState
public abstract int getState( )

Get the application state.

Returns:

application state

getProperty

public abstract java.lang.String
getProperty(java.lang.String aPropertyName)

Get an application property.

Parameters:

aPropertyName—the property to query

Returns:

Requested application property if present or null otherwise.

### Interface Downloader

### All Known Implementing Classes:

### JavaDownloader

public interface Downloader

Abstraction of download capability for installation allows customisation of the downloading mechanism. For example, a specific downloader may be used for OTA installation that will implement OTA requirements.

Method Summary

| | |
|---|---|
| java.lang.String | download(java.lang.String aUri, |
| | java.lang.String aReferrer) |
| | Download contents of the URI and return the path to the |
| | downloaded file. |

### Method Detail

download

```
public java.lang.String download(java.lang.String aUri,
                                java.lang.String aReferrer)
                throws AMSException
```

Download contents of the URI and return the path to the downloaded file.

The URI can be relative or absolute. When relative URI is supplied, the referrer parameter is used to obtain the complete URL.

Parameters:

aUri—Relative or absolute URI

aReferrer—If aUri is relative, referrer is used to obtain base URI

Returns:

The path to the downloaded file

Throws:

AMSException—If an error occurs

### All Known Implementing Classes:

### MIDletInfo, NativeAppInfo

public interface Executable

Interface common to all executable applications.

Method Summary

| | |
|---|---|
| AppInfo | getExecutableAppInfo( ) |
| | Get the AppInfo for this executable application. |
| Installable | getInstallable( ) |
| | Get the installable this application is associated with. |

### Method Detail

getInstallable
public Installable getInstallable( )

Get the installable this application is associated with.

Returns:

an Installable which is parent to this Executable

getExecutableAppInfo
public AppInfo getExecutableAppInfo( )

Get the AppInfo for this executable application.

Returns:

an AppInfo object containing information about this executable.

### Class Executor

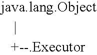

public class Executor
extends java.lang.Object

The executor class capable of starting, stopping switching between and querying currently available and running applications.

Method Summary

| | |
|---|---|
| static void | addListener(ExecutorListener aListener) |
| | Register a listener. |
| static void | close(Executable aExecutable) |
| | Stop a currently running executable. |
| static void | execute(Executable aExecutable) |
| | Run an executable. |
| static java.util.Enumeration | listExecutables( ) |
| | Return a list of executable applications. |
| static java.util.Enumeration | listRunning( ) |
| | Return a list of running applications. |
| static void | refresh( ) |
| | Clear any cached data. |
| static boolean | removeListener(ExecutorListener aListener) |
| | Unregister a listener. |
| static void | runSystem( ) |
| | Brings up the system ‘Launcher’ view. |
| static void | setUiHandler(AmsUI aUI) |
| | Set the UI for user interaction. |
| static void | switchTo(Executable aExecutable) |
| | Switch to an already running application. |

Methods inherited from class java.lang.Object
clone, equals, finalize, getClass, hashCode, notify, notifyAll, toString, wait, wait, wait

### Method Detail

setUiHandler
public static void setUiHandler(AmsUI aUI)

Set the UI for user interaction.

Note that queries are unicast—i.e. there cannot be multiple UI handlers registered within the same VM.

Setting the UI handler to null disables UI queries and response to all queries is assumed to be OPT_YES|OPT_OK.

Parameters:

aUI—the AmsUT instance to be used for user interaction.

addListener
public static void addListener(ExecutorListener aListener)

Register a listener.

Parameters:

aListener—the listener to add.

Throws:

java.lang.IllegalArgumentException—if supplied parameter is null

removeListener
public static boolean removeListener(ExecutorListener aListener)

Unregister a listener.

Parameters:

aListener—the listener to remove.

Returns:

true if the requested listener was registered, false otherwise.

Throws:

java.lang.IllegalArgumentException—if supplied parameter is null

listRunning

public static java.util.Enumeration listRunning( )
throws AMSException

Return a list of running applications.

Returns:

An Enumeration of Executable objects that represent currently running applications.

### AMSException

listExecutables

public static java.util.Enumeration listExecutables( )
throws AMSException

Return a list of executable applications.

Returns:

An Enumeration of Executable objects

### AMSException

close

public static void close(Executable aExecutable)
throws AMSException

Stop a cuffently running executable.

Parameters:

aExecutable—The executable to stop.

Throws:

AMsException—if an error occurs
refresh
public static void refresh( )

Clear any cached data. Obtain a fresh copy of data when it is requested.

execute

public static void execute(Executable aExecutable)
throws AMSException

Run an executable.

Parameters:

aExecutable—The executable to execute.

Throws:

AMSException—if an error occurs
switchTo

public static void switchTo(Executable aExecutable)
throws AMSException

Switch to an already running application.

Parameters:

aExecutable—The executable to execute.

Throws:

AMSException—if an error occurs
runSystem

public static void runSystem( )
throws AMSException

Brings up the system ‘Launcher’ view.

Throws:

AMSException—If an error occurs

### Interface ExecutorListener

public interface ExecutorListener

The ExecutorListener interface defines a set of callback methods allowing AMS application to be aware of changes external to the process the are executing in.

A very simple example of this is notification that an application has been closed after being started from the shell.

Method Summary

| | |
|---|---|
| void | appAdded(AmsEvent aEvent) |
| | Notifies the listener that an application has been installed. |
| void | appClosed(AmsEvent aEvent) |
| | Notifies the listener that an application has terminated. |
| void | appRemoved(AmsEvent aEvent) |
| | Notifies the listener that an application has been removed. |
| void | appstarted(AmsEvent aEvent) |
| | Notifies the listener that an application has started. |

### Method Detail

appStarted
public void appStarted(AMSEvent aEvent)

Notifies the listener that an application has started.

Parameters:

aEvent—An AmsEvent containing event details.

appClosed
public void appClosed(AmsEvent aEvent)

Notifies the listener that an application has terminated.

Parameters:

aEvent—An AmsEvent containing event details.

appAdded
public void appAdded(AmsEvent aEvent)

Notifies the listener that an application has been installed.

Parameters:

aEvent—An AmsEvent containing event details.

appRemoved
public void appRemoved (AmsEvent aEvent)

Notifies the listener that an application has been removed.

Parameters:

aEvent—An AmsEvent containing event details.

### Class File

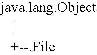

public class File
extends java.lang.Object

A minimal File class, stores file name, allows getting parent and checking weather the file is a directory.

Field Summary

| | |
|---|---|
| static int | KEntryAttArchive |
| static int | KEntryAttDir |
| static int | KEntryAttHidden |
| static int | KEntryAttReadOnly |
| static int | KEntryAttSystem |
| static int | KEntryAttVolume |

Method Summary

| | |
|---|---|
| java.lang.String | getAbsolutePath( ) |
| | Return the full path to this file, including the file name. |
| java.lang.String | getName( ) |
| | Return the name of the file or directory without path. |
| java.lang.String | getPath( ) |
| | Return the full path to this file, without the file name. |
| boolean | isDirectory( ) |
| | Check weather this file is a directory. |
| boolean | isHidden( ) |
| | Check weather this file is a directory. |
| boolean | isReadOnly( ) |
| | Check weather this file is a directory. |
| boolean | isRoot( ) |
| | Check weather this file is a root. |
| boolean | isSystem( ) |
| | Check weather this file is a directory. |

Methods inherited from class java.lang.Object
clone, equals, finalize, getClass, hashCode, notify, notifyAll, toString, wait, wait, wait

### Field Detail

### KEntryAttReadOnly

public static final int KEntryAttReadOnly

### KEntryAttHidden

public static final int KEntryAttHidden

### KEntryAttSystem

public static final int KEntryAttSystem

### KEntryAttVolume

public static final int KEntryAttVolume

### KEntryAttDir

public static final int KEntryAttDir

### KEntryAttArchive

public static final int KEntryAttArchive

### Method Detail

isDirectory
public boolean isDirectory( )

Check weather this file is a directory.

Returns:

Throws:

java.lang.Exception

isRoot
public boolean isRoot( )

Check weather this file is a root.

Returns:

Throws:

java.lang.Exception

isReadOnly
public boolean isReadOnly( )

Check weather this file is a directory.

Returns:

Throws:

java.lang.Exception

isHidden
public boolean isHidden( )

Check weather this file is a directory.

Returns:

Throws:

java.lang.Exception

isSystem
public boolean isSystem( )

Check weather this file is a directory.

Returns:

Throws:

java.lang.Exception

getPath

public java.lang.String getPath( )

Return the full path to this file, without the file name.

Returns:

the full path to this file without the file name

getName
public java.lang.String getName( )

Return the name of the file or directory without path.

Returns:

the name of the file or directory without path

getAbsolutePath
public java.lang.String getAbsolutePath( )

Return the full path to this file, including the file name.

Returns:

the full path to this file including the file name

### Class FileSystem

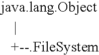

public class FileSystem
extends java.lang.Object

A minimal, peerless, FileSystem access interface, allows listing present drives, directory contents, and loading files.

### Constructor Summary

### FileSystem( )

Method Summary

| | |
|---|---|
| static java.util.Enumeration | listFiles(java.lang.String aDirectory) |
| | Return enumeration of File objects repre- |
| | senting all files in the specified directory. |
| static java.util.Enumeration | listRoots( ) |
| | Return the list of drives present on the |
| | device. |
| static byte[ ] | loadFile(java.lang.String aFile) |
| | Load contents of a file. |

Methods inherited from class java.lang.Object
clone, equals, finalize, getClass, hashCode, notify, notifyAll, toString, wait, wait, wait

### Constructor Detail

### FileSystem

public FileSystem( )

### Method Detail

listRoots
public static java.util.Enumeration listRoots( )

Return the list of drives present on the device.

Returns:

list of drives currently present on the device

listFiles

public static java.util.Enumeration listFiles(java.lang.String aDirectory)
throws java.lang.Exception

Return enumeration of File objects representing all files in the specified directory.

Parameters:

aDirectory—The directory to list.

Returns:

Enumeration of all files in the specified directory

Throws:

java.lang.Exception—If the parameter does not exist or is not a directory.

loadFile

public static byte[ ] loadFile(java.lang.String aFile)
throws java.io.IOException

Load contents of a file.

Parameters:

aFile—The path to the file to load.

Returns:

The contents of the file

Throws:

java.io.IOException—if an IO enor occurs

### Interface Installable

### All Known Implementing Classes:

### MIDletSuiteInfo, NativeAppInfo

public interface Installable

Interface common to installable applications.

Method Summary

| | |
|---|---|
| java.util.Enumeration | getExecutables( ) |
| | List executables associated with this installable. |
| AppInfo | getInstallableAppInfo( ) |
| | Get the AppInfo object that represents this |
| | installable application. |

### Method Detail

getExecutables
public java.util.Enumeration getExecutables( )

List executables associated with this installable.

Returns:

An enumeration of Executable objects

getInstallableAppInfo
public AppInfo getInstallableAppInfo( )

Get the AppInfo object that represents this installable application.

Returns:

An AppInfo object referring to this Installable

### Class Installer

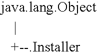

public class Installer
extends java.lang.Object

The installer provides the necessary methods for installation of both, MIDlet suites and native applications.

Method Summary

| | |
|---|---|
| static void | addListener(InstallerListener aListener) |
| | Register a listener. |
| static void | install(java.lang.String aFile) |
| | Install an application from a file. |
| static java.util.Enumeration | listInstalledApps( ) |
| | Lists installed applications. |
| static void | refresh( ) |
| | Clear any cached data. |
| static void | remove(Installable aInstallable) |
| | Uninstall specified application. |
| static boolean | removeListener(InstallerListener aListener) |
| | Unregister a listener. |
| static void | setUiHandler(AmsUI aUI) |
| | Set the UI for user interaction. |
| static void | update(Installable aInstallable) |
| | Update specified application. |

Methods inherited from class java.lang.Object
clone, equals, finalize, getClass, hashCode, notify, notifyAll, toString, wait, wait, wait

### Method Detail

### SetUiHandler

public static void setUiHandler (AmsUI aUI)

Set the UI for user interaction.

Parameters:

aUI—the AmsUT instance to be used for user interaction.

addListener
public static void addListener(InstallerListener aListener)

Register a listener.

Parameters:

aListener—The listener to register

removeListener
public static boolean removeListener(InstailerListener aListener)

Unregister a listener.

Parameters:

aListener—The listener to unregister

Returns:

If the listener was not registered at the time of this call, this method returns false, otherwise it returns true.

Throws:

java.lang.IllegalArgumentException—if the supplied listener is null.

listInstalledApps

public static java.util.Enumeration listInstalledApps( )
throws AMSException

Lists installed applications.

Returned list will contain all native applications and MIDlet suites, but not individual MIDlets.

Returns:

An Enumeration of Installable objects

Throws:

AMSException—if an error occurs
install

public static void install(java.lang.String aFile)
throws AMSException

Install an application from a file.

The file can point to one of three file types:
jad—Java application descriptor
jar—Java archive
zip—Used to install native applications

Parameters:

aFile—the file to install

Throws:

AMSException—if an error occurs
remove

public static void remove(Installable aInstallable)
throws AMSException

Uninstall specified application.

Parameters:

aInstallable—The installable to uninstall

Throws:

AMSException—if an error occurs
refresh
public static void refresh( )

Clear any cached data. Obtain a fresh copy of data when it is requested.

update

public static void update(Installable aInstallable)
throws AMSException

Update specified application.

Parameters:

aInstallable—the installable to update

Throws:

AMSException—if an error occurs

### Interface InstallerListener

By implementing this interface applications can subscribe to notifications of installation, update and uninstallation of applications.

The typical action would be refreshing the user interface which displays installed applications.

Method Summary

| | |
|---|---|
| void | appInstalled (AmsEvent aEvent) |
| | Notifies the listener that an application has been installed. |
| void | appRemoved (AmsEvent aEvent) |
| | Notifies the listener that an application has been removed. |
| void | appUpdated (AmsEvent aEvent) |
| | Notifies the listener that an application has been updated. |

### Method Detail

appInstalled
public void appInstalled(AmsEvent aEvent)

Notifies the listener that an application has been installed.

Parameters:

aEvent—An AmsEvent containing event details.

appUpdated
public void appUpdated(AmsEvent aEvent)

Notifies the listener that an application has been updated.

Parameters:

aEvent—An AmsEvent containing event details.

### app Removed

public void appRemoved(AmsEvent aEvent)

Notifies the listener that an application has been removed.

Parameters:

aEvent—An AmsEvent containing event details.

### Class JavaDownloader

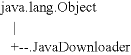

### All Implemented Interfaces:

### Downloader

public class JavaDownloader
extends java.lang.Object
implements Downloader

Simple implementation of the Downloader interface allowing installation from local drive.

### Constructor Summary

### JavaDownloader( )

Create a new JavaDownloader.

Method Summary

| | |
|---|---|
| java.lang.String | download(java.lang.String aUri, |
| | java.lang.String aReferrer) |
| | Returns the path to the file to install. |

Methods inherited from class java.lang.Object
clone, equals, finalize, getClass, hashCode, notify, notifyAll, toString, wait, wait, wait

### Constructor Detail

### JavaDownloader

public JavaDownloader( )

Create a new JavaDownloader.

### Method Detail

download

```
public java.lang.String download(java.lang.String aUri,
                            java.lang.String aReferrer)
            throws AMSException
```

Returns the path to the file to install. If a Uri is relative, referrer is used to determine full file path.

Specified by:

download in interface Downloader

Parameters:

aUri—Absolute or relative path to the file to install.

aReferrer—If aUri is relative, aReferrer is used to determine full file path

Returns:

The path to the file to install.

### Class MIDletInfo

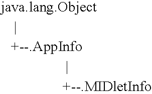

### All Implemented Interfaces:

### Executable

public final class MIDletInfo
extends AppInfo
implements Executable
Holds basic MIDlet information.

### Field Summary

Fields inherited from class .AppInfo

### RUNNING, STOPPED

Method Summary

| | |
|---|---|
| boolean | equals(java.lang.Object aOther) |
| | Compare this object with another object. |
| AppInfo | getAppInfo( ) |
| | Returns this reference. |
| AppInfo | getExecutableAppInfo( ) |
| | Implementation of Executable. |
| java.lang.String | getIcon( ) |
| | Get the application icon. |
| Installable | getInstallable( ) |
| | Get the installable that encloses this Executable. |
| MIDletSuiteInfo | getMIDletSuiteInfo( ) |
| | Get the enclosing MIDlet suite. |
| java.lang.String | getName( ) |
| | Get the MIDlet name |
| java.lang.String | getProperty(java.lang.String aPropertyName) |
| | Implementation of AppInfo. |
| int | getState( ) |
| | Get the MIDlet state. |

Methods inherited from class java.lang.Object
clone, finalize, getClass, hashCode, notify, notifyAll, toString, wait, wait, wait

### Method Detail

getName
public java.lang.String getName( )

Get the MIDlet name

Specified by:

getName in class AppInfo

Returns:

the MIDlet name

getIcon
public java.lang.String getIcon( )

Get the application icon.

Specified by:

getIcon in class AppInfo

Returns:

the application icon

getProperty
public java.lang.String getProperty(java.lang.String aPropertyName)

Implementation of AppInfo.

Specified by:

getProperty in class AppInfo

Parameters:

aPropertyName—the property name to query.

Returns:

Returns null as native application properties are not supported.

getExecutableAppInfo
public AppInfo getExecutableAppInfo( )

Implementation of Executable.

Specified by:

qetExecutableAppInfo in interface Executable

Returns:

reference to this object.

getState
public int getState( )

Get the MIDlet state.

Specified by:

getState in class AppInfo

Returns:

MIDlet state

getMIDletSuiteInfo
public MIDletSuiteInfo getMIDletSuiteInfo( )

Get the enclosing MIDlet suite.

Returns:

the enclosing MIDlet suite descriptor object

equals
public boolean equals(java.lang.Object aOther)

Compare this object with another object.

Overrides:

equals in class java.lang.object

Parameters:

aOther—The object to compare to.

Returns:

true if supplied MIDletInfo object belongs to the same MIDlet suite and has the same MIDlet ID as this object.

getInstallable
public Instaliable getInstallable( )

Get the installable that encloses this Executable.

Specified by:

getInstallable in interface Executable

Returns:

The installable which is parent to this executable

getAppInfo
public AppInfo getAppInfo( )

Returns this reference. This method implements Executable interface.

Returns:

this reference

### Class MIDletInfo

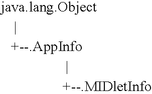

### All Implemented Interfaces:

### Executable

public final class MIDletInfo
extends AppInfo
implements Executable
Holds basic MIDlet information.

### Field Summary

Fields inherited from class .AppInfo

### RUNNING, STOPPED

Method Summary

| | |
|---|---|
| boolean | equals(java.lang.Object aOther) |
| | Compare this object with another object. |
| AppInfo | getAppInfo( ) |
| | Returns this reference. |
| AppInfo | getExecutableAppInfo( ) |
| | Implementation of Executable. |
| java.lang.String | getIcon( ) |
| | Get the application icon. |
| Installable | getInstallable( ) |
| | Get the installable that encloses this Executable. |
| MIDletSuiteInfo | getMIDletSuiteInfo( ) |
| | Get the enclosing MIDlet suite. |
| java.lang.String | getName( ) |
| | Get the MIDlet name |
| java.lang.String | getProperty(java.lang.String aPropertyName) |
| | Implementation of AppInfo. |
| int | getState( ) |
| | Get the MIDlet state. |

Methods inherited from class java.lang.Object
clone, finalize, getClass, hashCode, notify, notifyAll, toString, wait, wait, wait

### Method Detail

getName
public java.lang.String getName( )

Get the MIDlet name

Specified by:

getName in class AppInfo

Returns:

the MIDlet name

getIcon
public java.lang.String getIcon( )

Get the application icon.

Specified by:

getIcon in class AppInfo

Returns:

the application icon

getProperty
public java.lang.String getProperty(java.lang.String aPropertyName)

Implementation of AppInfo.

Specified by:

getProperty in class AppInfo

Parameters:

aPropertyName—the property name to query.

Returns:

Returns null as native application properties are not supported.

getExecutableAppInfo
public AppInfo getExecutableAppInfo( )

Implementation of Executable.

Specified by:

getExecutableAppInfo in interface Executable.

Returns:

reference to this object.

getState
public int getState( )

Get the MIDlet state.

Specified by:

getState in class AppInfo

Returns:

MIDlet state

getMIDletSuiteInfo
public MIDletSuiteInfo getMIDletSuiteInfo( )

Get the enclosing MIDlet suite.

Returns:

the enclosing MIDlet suite descriptor object

equals
public boolean equals(java.lang.Object aOther)

Compare this object with another object.

Overrides:

equals in class java.lang.Object

Parameters:

aOther—The object to compare to.

Returns:

true if supplied MIDletInfo object belongs to the same MIDlet suite and has the same MIDlet ID as this object.

getInstallable
public Installable getInstallable( )

Get the installable that encloses this Executable.

Specified by:

getInstallable in interface Executable

Returns:

The installable which is parent to this executable

getAppInfo
public AppInfo getAppInfo( )

Returns this reference. This method implements Executable interface.

Returns:

this reference

### Class MIDletSuiteInfo

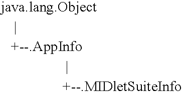

### All Implemented Interfaces:

### Installable

public class MIDletSuiteInfo
extends AppInfo
implements Installable
Holds basic MIDletSuite information.

### Field Summary

Fields inherited from class .AppInfo

### RUNNING, STOPPED

Method Summary

| | |
|---|---|
| boolean | equals (java.lang.Object aOther) |
| | Test weather this MIDletSuiteInfo refers to the |
| | same MIDlet suite as the supplied parameter. |
| java.util.Enumeration | getExecutables( ) |
| | Implementation of Installable. |
| java.lang.String | getIcon( ) |
| | Get the application icon. |
| AppInfo | getInstallableAppInfo( ) |
| | Implementation of Installable. |
| MIDletInfo[ ] | getMIDletInfo( ) |
| | Get MIDlets. |
| java.lang.String | getName( ) |
| | Get the MIDlet suite name. |
| java.lang.String | getProperty(java.lang.String aPropertyName) |
| | Implementation of AppInfo. |
| int | getState( ) |
| | Get the application state. |
| java.lang.String | getVendor( ) |
| | Get the MIDlet suite vendor. |
| java.lang.String | getVersion( ) |
| | Get the MIDlet suite version. |

Methods inherited from class java.lang.Object
clone, finalize, getClass, hashCode, notify, notifyAll, toString, wait, wait, wait

### Method Detail

getName
public java.lang.String getName( )

Get the MIDlet suite name.

Specified by:

getName in class AppInfo

Returns:

the MIDlet suite name

getIcon
public java.lang.String getIcon( )

Get the application icon.

Specified by:

getIcon in class AppInfo

Returns:

the application icon

### get Vendor

public java.lang.String getVendor( )

Get the MIDlet suite vendor.

Returns:

the MIDlet suite vendor

getVersion
public java.lang.String getVersion( )

Get the MIDlet suite version.

Returns:

the MIDlet suite version

getMIDletInfo
public MIDletInfo[] getMIDletInfo( )

Get MIDlets.

Returns:

An array of MIDletInfo objects conesponding to MIDlets from this MIDlet suite

equals
public boolean equals(java.lang.Object aOther)

Test whether this MIDletSuiteInfo refers to the same MIDlet suite as the supplied parameter.

Overrides:

equals in class java.lang.Object

Parameters:

aOther—object to compare to

Returns:

true if the two MIDletSuiteInfo objects refer to the same MIDlet suite. false otherwise.

getInstallableAppInfo
public AppInfo getInstallableAppInfo( )

Implementation of Installable.

Specified by:

getInstallableAppInfo in interface Installable

Returns:

reference to this object.

getExecutables
public java.util.Enumeration getExecutables( )

Implementation of Installable. List executables associated with this installable.

Specified by:

getExecutables in interface Installable

Returns:

An enumeration of Executable objects

getProperty
public java.lang.String getProperty(java.lang.String aPropertyName)

Implementation of AppInfo.

Specified by:

getProperty in class AppInfo

Parameters:

aPropertyName—the property name to query.

Returns:

Returns null as native application properties are not supported.

getState
public int getState( )

Get the application state.

Specified by:

getState in class AppInfo

Returns:

application state

### Class MRUCache

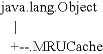

public class MRUCache
extends java.lang.Object
Most recently used (MRU) object cache.

### Constructor Summary

### MRUCache ( )

Create a new cache with maximum size of 20 entries.

MRUCache (int aMaxEntries)

Create a new cache with specified maximum size.

Method Summary

| | |
|---|---|
| boolean | containsKey(java.lang.Object aKey) |
| | Checks if the cache contains specified key. |
| java.lang.Object | get(java.lang.Object aKey) |
| | Moves requested item to front of cache |
| void | put(java.lang.Object aKey, java.lang.Object aData) |
| | Stores an object in the cache by placing it at the top |
| | of the list Ifthe object is in the cache, it promotes it |
| | to the top of the list. |
| void | remove(java.lang.Object aKey) |

Methods inherited from class java.lang.Object
clone, equals, finalize, getClass, hashCode, notify, notifyAll, toString, wait, wait, wait

### Constructor Detail

### MRUCache

public MRUCache( )

Create a new cache with maximum size of 20 entries.

### MRUCache

public MRUCache(int aMaxEntries)

Create a new cache with specified maximum size.

### Parameters:

aMaxEntries—The maximum number of objects this cache object can store.

### Method Detail

containsKey
public boolean containsKey(java.lang.Object aKey)

Checks if the cache contains specified key.

Returns:

true if the key exists in the cache.

put

public void put(java.lang.Object aKey,
java.lang.Object aData)

This method stores an object in the cache by placing it at the top of the list If the object is in the cache, it promotes it to the top of the list. If the object is not in the cache, it adds it to the top of the list, and then checks the max size of the cache versus the new size to see if it needs to remove the last element from the cache.

remove
public void remove(java.lang.Object aKey)
get
public java.lang.Object get (java.lang.Object aKey)

Moves requested item to front of cache

### Class NativeAppInfo

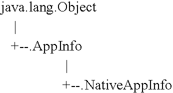

### All Implemented Interfaces:

### Executable, Installable

public class NativeAppInfo
extends AppInfo
implements Installable, Executable
NativeAppInfo is a native application descriptor.

### Field Summary

Fields inherited from class .AppInfo

### RUNNING, STOPPED

Method Summary

| | |
|---|---|
| AppInfo | getExecutableAppInfo( ) |
| | Implementation of Executable. |
| java.util.Enumeration | getExecutables( ) |
| | Implementation of Installable. |
| java.lang.String | getIcon( ) |
| | Get the application icon. |
| Installable | getInstallable( ) |
| | Get the installable this application is associated |
| | with. |
| AppInfo | getInstallableAppInfo( ) |
| | Implementation of Installable. |
| java.lang.String | getName( ) |
| | Get the application name. |
| java.lang.String | getProperty(java.lang.String aPropertyName) |
| | Implementation of installable. |
| int | getState( ) |
| | Get the application state. |

Methods inherited from class java.lang.Object
clone, equals, finalize, getClass, hashCode, notify, notifyAll, toString, wait, wait, wait

### Method Detail

getName
public java.lang.String getName( )

Get the application name.

Specified by:

getName in class AppInfo

Returns:

the application name

getIcon
public java.lang.String getIcon( )

Get the application icon.

Specified by:

getIcon in class AppInfo

Returns:

the application icon

getState
public int getState( )

Get the application state.

Specified by:

getState in class AppInfo

Returns:

application state

See Also:

AppInfo.STOPPED, AppInfo.RUNNING

getExecutableAppInfo
public AppInfo getExecutableAppInfo( )

Implementation of Executable.

Specified by:

getExecutableAppInfo in interface Executable

Returns:

reference to this object.

getInstallable
public Installable getInstallable( )
Description copied from interface: Executable

Get the installable this application is associated with.

Specified by:

getInstallable in interface Executable

Returns:

an Installable which is parent to this Executable

getInstallableAppInfo
public AppInfo getInstallableAppInfo( )

Implementation of Installable.

Specified by:

getInstallableAppInfo in interface Installable

Returns:

reference to this object.

getExecutables
public java.util.Enumeration getExecutables( )

Implementation of Installable. List executables associated with this installable.

Specified by:

getExecutables in interface Installable

Returns:

An enumeration of Executable objects

getProperty
public java.lang.String getProperty (java.lang.String aPropertyName)

Implementation of installable.

Specified by:

getProperty in class AppInfo

Parameters

aPropertyName—the property to query

Returns:

Returns null as native application properties are not supported.

It can be seen from the above embodiment that the present invention discloses a means of providing a single operating system method that can centrally manage
application lifecycle (including installation, execution status, removal)
application capabilities
long-lived OS level application owned resources (e.g. push connections, alarms)
security
   for any application, regardless of application type or model or execution environment.

Hence, the present invention is considered to provide several advantages over the known methods for application management, including;
The entire application lifecycle, including all phases of installation, execution, termination and removal, is managed from a single unified AMS entity.
The unified AMS supports application owned OS level resources (such as connections and alarms) whose lifetime extends beyond that of the application execution.
The unified AMS can be easily adapted and extended for any application type.
The unified AMS supports multiple execution models and multiple execution subsystems.
The unified AMS can be easily adapted and extended for any new execution models and subsystems.
A single application management system is able to handle (for example) native applications, Java applications, BREW applications and Appforge-style Visual Basic applications
The AMS is an operating system service which has a monopoly on installing and running all type of executables; this enables a common security policy to be implemented across the whole system.

Although the present invention has been described with reference to particular embodiments, it will be appreciated that modifications may be effected whilst remaining within the scope of the present invention as defined by the appended claims.

1. A method of managing application lifecycle for user applications on a computing device, the method comprising providing an application management system (AMS) for managing a plurality of application models and a plurality of application environments, wherein the AMS is implemented as a component within an operating system for the computing device and grants to the operating system control for all application management functionality on the device.

2. A method according to claim 1 wherein the user applications comprise any one or more of, in any combination;
a. a native application which interacts directly with the operating system on the device;
b. a Java application of any type including but not limited to unmanaged applications, midlets, applets and xlets for interaction with a Java Virtual Machine;
c. an application designed for the BREW application environment;
d. an application designed to run via a language interpreter including but not limited to Fortran, Forth, Lisp, BASIC, Visual Basic or Perl;
e. an application designed to run inside a Web Browser;
f. an application written in intermediate code, such as a
Pascal application written in pCode;
g. an application written in machine code for the processor or processors used in the device; or
h. any other type of program designed to run on the device under any other application model and/or run-time subsystem.

3. A method according to claim 1 wherein the AMS is extensible for permitting support to be added for further application models and/or run-time subsystems.

4. A method according to claim 1 wherein the application lifecycle comprises any one or more of, in any combination;
a. the installation of an application;
b. the loading of an application;
c. the execution of an application;
d. the suspension of an application;
e. the resumption of an application
f. the termination of an application;
g. the removal or deinstallation of an application; or
h. any other lifecycle operation for an application.

5. A method according to claim 1 wherein the AMS manages operating system or hardware resources which are owned by or associated with any user application.

6. A method according to claim 5 wherein the AMS is able to alter the lifecycle state of any application in response to an alteration in the state of an operating system or hardware resource which is owned by or associated with the said application.

7. A method according to claim 1 wherein the AMS is arranged to manage the security attributes of any application.

8. A method according to claim 1 wherein the AMS maintains a record of any or all of the following:
a. all applications currently installed on the device;
b. the state of all running applications;
c. operating system resources;
d. hardware resources;
e. a set of mappings of hardware and/or operating system resources to resource related events, applications, application states, and actions.

9. A method according to claim 1 wherein the AMS comprises a server to which multiple applications can connect as clients.

10. A method according to claim 1 wherein multiple instances of an application can be independently managed by the AMS.

11. A method according to claim 1 wherein a first set of functions handle the application states relating to installation and removal of all applications and a further set of functions handle the application states relating to the execution of each instance of all applications.

12. A method according to claim 1 in which one or more sets of AMS listener functions provide applications with event notifications.

13. A method according to claim 1 in which the AMS comprises a layered architecture which includes a public API providing access to the functionality required for lifecycle and resource management.

14. A method according to claim 1 in which application subsystem or run-time environments for all applications or executables which are unable to directly access native AMS APIs provide a set of insulation layers which enable such applications.

15. A method according to claim 1 in which the actions taken by any part of the AMS are modified by the security attributes assigned to system or user applications.

16. A method according to claim 1 in which the actions taken by any part of the AMS are modified by the security attributes assigned to the current user of the device.

17. A method according to claim 1 wherein installing and executing any type of executable code on the device is restricted to the use of the AMS.

18. A method according to claim 1 wherein the user applications comprise all independently installable items of executable code irrespective of whether they are independently executable, such as a library or a plug-in providing extended functionality.

19. A method according to claim 1 wherein the user applications comprise all independently installable data sets which affect the running of any application.

20. (canceled)

21. (canceled)

22. A computing device managing application lifecycles for user applications on the computing device, comprising:
an application management system (AMS) stored on said computing device, managing a plurality of application models and a plurality of application environments, wherein the AMS is implemented as a component within an operating system for the computing device and grants to the operating system control for all application management functionality on the device.

23. An operating system for managing an application lifecycle for user applications on a computing device, comprising a computer-readable storage medium having computer-readable program code embodied in the medium, the computer-readable program code comprising:
computer-readable code providing an application management system (AMS) for managing a plurality of application models and a plurality of application environments, wherein the AMS is implemented as a component within an operating system for the computing device and grants to the operating system control for all application management functionality on the device.
